(19) United States
(12) Patent Application Publication
(10) Pub. No.: US 2026/0193100 A1
(43) Pub. Date: Jul. 9, 2026

(54) METHOD FOR MANUFACTURING POSITIVE ELECTRODE PARTICLES COATED WITH CERAMIC PARTICLES USING DRY MIXING AND SINGLE-STAGE SINTERING

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 19/012,911

(22) Filed: Jan. 8, 2025

(51) Int. Cl. C01G 53/506; H01M 4/02; H01M 4/36; H01M 10/0562

(52) U.S. Cl. CPC C01G 53/506; H01M 4/366; H01M 10/0562; C01P 2004/32; C01P 2004/61; C01P 2004/84; C01P 2006/40; H01M 2004/028; H01M 2300/0077

(57) ABSTRACT

A method for manufacturing positive electrode particles coated with ceramic particles using a dry mixing and a single-stage sintering includes the steps of: mixing a nickel-cobalt-manganese hydroxide precursor, a lithium source and a LLZO precursor using a mixer to form a precursor mixture; then placing the precursor mixture into a sintering furnace and performing an oxygen assisted sintering to obtain a sintered powder formed by plural positive electrode particles, wherein each of the positive electrode particles includes a corresponding NCM particle coated with plural corresponding LLZO particles; then performing a mechanical crushing on the sintered powder and performing a sifting on the sintered powder using a sifter; and then the sintered powders is mixed with plural first carbon nanotubes and plural nanoscale amorphous carbons to form plural carbon-material-coated positive electrode particles.

### FIELD OF THE INVENTION

The present invention is related to a positive electrode material of a battery, and in particular to a method for manufacturing positive electrode particles coated with ceramic particles using a dry mixing and a single-stage sintering.

### BACKGROUND OF THE INVENTION

A typical battery is mainly formed by the positive and negative electrodes placed in the electrolyte. The positive electrode is made by mixing and dispersing a large number of positive conductive units (positive electrode material, such as lithium cobalt oxide) in a positive slurry. To increase the conductivity, the positive slurry is filled with plural positive electrode particles which may be formed by NCM (lithium nickel manganese cobalt oxide) or NCM-contained mixtures.

The interface of traditional positive electrode particles is easy to perform a side reaction and has a lower electrical conductivity, resulting a reduction of the life of positive electrode and a poor battery performance. Therefore, the traditional positive electrode particles are further coated with ceramic particles (such as LLZO) to improve the lithium conductivity. Carbon nanotubes and nanoscale amorphous carbons also can be coated on the positive electrode particles for improving the electric conductivity.

However, the method for manufacturing above composite positive electrode particles coated with ceramic particles use a two-stage sintering, which is costly and time-consuming, resulting in higher manufacturing costs.

### SUMMARY OF THE INVENTION

Accordingly, for improving above mentioned defects in the prior art, the object of the present invention is to provide a method for manufacturing positive electrode particles coated with ceramic particles using a dry mixing and a single-stage sintering, wherein an outer surface of the NCM particle is coated with LLZO particles. The LLZO particles have the ability of accommodating and guiding the lithium ions. The present invention use a single-stage sintering on the nickel-cobalt-manganese hydroxide precursor, lithium source and LLZO precursor to form the positive electrode particles, which reduces the manufacturing complexity, manufacturing time and production costs. The first carbon nanotubes and nanoscale amorphous carbons are further coated on the positive electrode particles for improving the electric conducting efficiency. The positive electrode having the positive electrode particles of the present invention can form a ternary cathode.

To achieve above object, the present invention provides a method for manufacturing positive electrode particles coated with ceramic particles using a dry mixing and a single-stage sintering; the positive electrode particles being used in a positive electrode inside a solid-state battery or semi-solid battery; the method comprising the steps of: step A: placing a nickel-cobalt-manganese hydroxide precursor, a lithium source and a LLZO (lithium lanthanum zirconium oxide) precursor into a mixer; then mixing the nickel-cobalt-manganese hydroxide precursor, the lithium source and the LLZO precursor using the mixer to form a precursor mixture; wherein the nickel-cobalt-manganese hydroxide precursor is a hydroxide precursor for NCM (lithium nickel manganese cobalt oxide); the LLZO precursor is a precursor for LLZO, and the LLZO serves to form the ceramic particles; the nickel-cobalt-manganese hydroxide precursor is a granular material formed by plural particles; and an outer surface of each of the particles of nickel-cobalt-manganese hydroxide precursor has plural holes; step B: placing the precursor mixture into a sintering furnace and performing an oxygen assisted sintering using the sintering furnace to obtain a sintered powder formed by a plurality of positive electrode particles; wherein a melting point of the lithium source is lower than the nickel-cobalt-manganese hydroxide precursor and the LLZO precursor to cause that the lithium source is first melted and is filled into the holes of the nickel-cobalt-manganese hydroxide precursor in the oxygen assisted sintering, and then the lithium source is decomposed to form a lithium oxide with a specific reactivity; the lithium oxide is reacted with the nickel-cobalt-manganese hydroxide precursor to form a plurality of NCM (lithium nickel manganese cobalt oxide) particles and is reacted with the LLZO precursor to form a plurality of LLZO particles; the LLZO particles are coated on an outer surface of the NCM particle; each of the positive electrode particles includes a corresponding NCM particle coated with corresponding LLZO particles.

### BRIEF DESCRIPTION OF THE DRAWINGS

FIG. 1 is a steps flow diagram showing the process of the present invention.

FIG. 2 is a schematic view showing the process of the present invention.

FIG. 3 is a schematic view showing the full structure and the partial structure of the positive electrode particle of the present invention.

FIG. 4 is a cross-section view showing the structure of the positive electrode particle of the present invention.

FIG. 5 is a schematic view showing an application of the present invention.

FIG. 6 is a schematic view showing the structure of the carbon-nanotube-coated positive electrode particle of the present invention.

FIG. 7 is a schematic view showing the structure of the nickel-cobalt-manganese hydroxide precursor of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

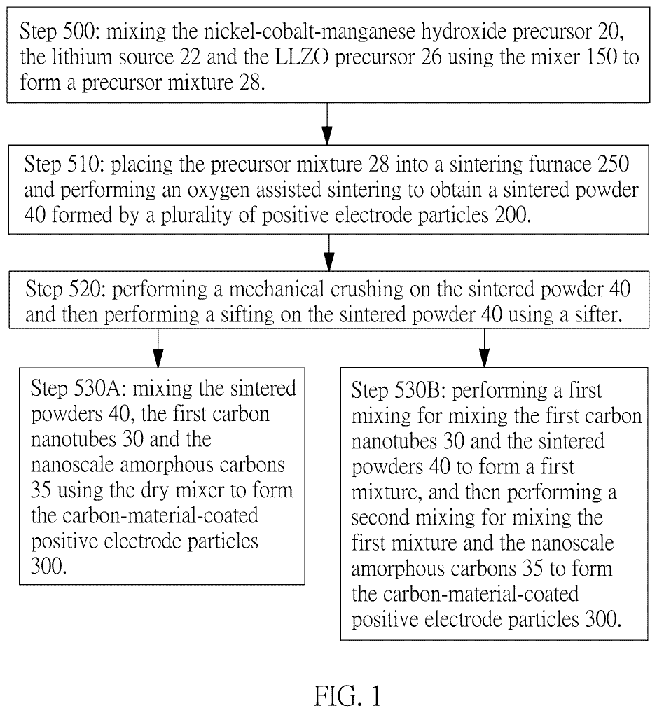

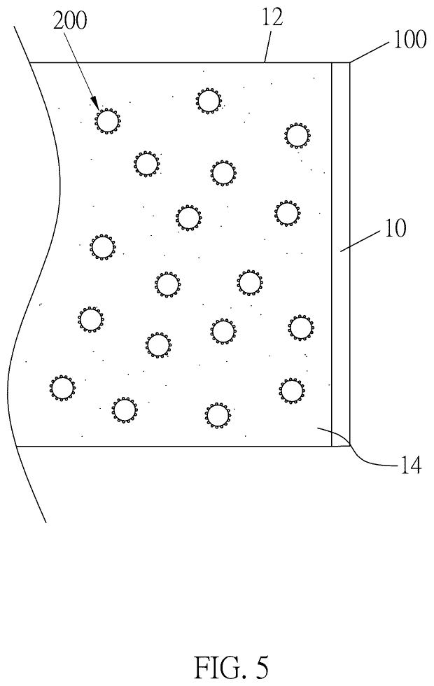

With reference to FIGS. 1 to 7, the present invention provides a method for manufacturing positive electrode particles coated with ceramic particles using a dry mixing and a single-stage sintering, wherein the positive electrode particles are used in a positive (+) electrode 100 inside a solid-state battery or semi-solid battery. Referring to FIG. 5, the positive electrode 100 includes a positive substrate 10 and a positive slurry layer 12 coated on the positive substrate 10. The positive slurry layer 12 includes the positive electrode particles 200 and a positive slurry 14 with a binder. The binder may be PVDF (polyvinylidene difluoride) or PEO (polyethylene oxide). A weight percentage of the positive electrode particles 200 in the positive slurry layer 12 is 80 wt %~98 wt %.

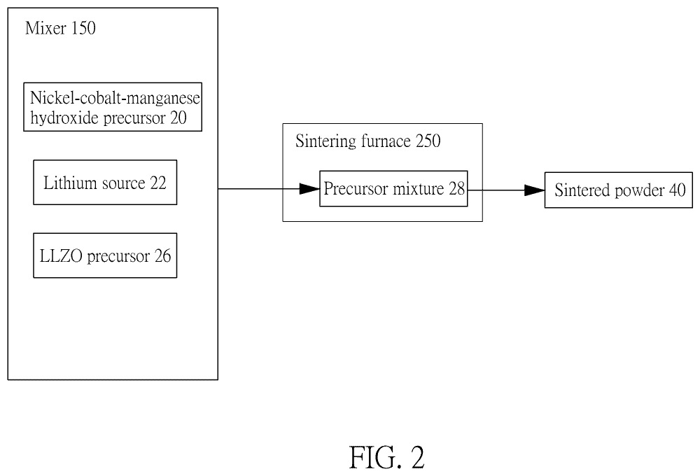

The method of the present invention is used to manufacture the positive electrode particles 200. Referring to FIGS. 1 and 2, the method comprises the following steps of:
Step 500: placing a nickel-cobalt-manganese hydroxide precursor 20, a lithium source 22 and a LLZO (lithium lanthanum zirconium oxide) precursor 26 into a mixer 150; then mixing the nickel-cobalt-manganese hydroxide precursor 20, the lithium source 22 and the LLZO precursor 26 using the mixer 150 to form a precursor mixture 28. An equivalent ratio of the nickel-cobalt-manganese hydroxide precursor 20, the lithium source 22 and the LLZO precursor 26 is 1.0: (1.02~1.25):(0.005~0.02). The nickel-cobalt-manganese hydroxide precursor is a hydroxide precursor for NCM (lithium nickel manganese cobalt oxide). The LLZO precursor 26 is a precursor for LLZO, and the LLZO serves to form the ceramic particles.

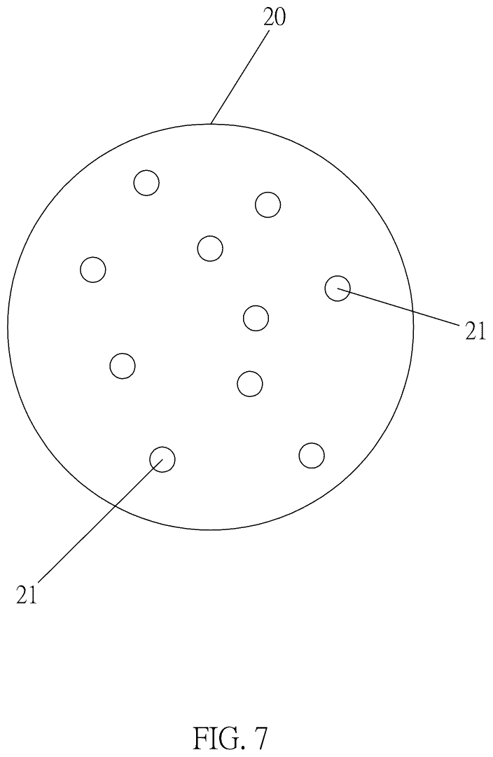

The nickel-cobalt-manganese hydroxide precursor 20 is a granular material formed by plural particles. Referring to FIG. 7, an outer surface of each of the particles of nickel-cobalt-manganese hydroxide precursor 20 has plural holes 21. A particle size of the nickel-cobalt-manganese hydroxide precursor 20 is 1 μm~5 μm. Preferably, the nickel-cobalt-manganese hydroxide precursor 20 is a spherical precursor formed by whisker-like nickel-cobalt-manganese hydroxide, such as NiₓMn_{y}Co_{z}(OH)₂, wherein x>0.8 and x+y+z=1.

The lithium source 22 is formed by at least one of lithium hydroxide (LiOH), lithium carbonate (Li₂CO₃) and lithium nitrate (LiNO₃).

The LLZO precursor 26 is a granular material formed by plural particles. The LLZO precursor 26 is formed by specific materials capable of forming a garnet-based solid-state electrolyte (such as Li₇La₃Zr₂O₁₂) with a cubic crystal system (a crystal structure with a specific element arrangement) by a co-firing with the lithium source 22. The specific materials include at least one of oxide, hydroxide and carbonate. A reaction intermediate formed by a coprecipitation or sintering of the specific materials has a structure with a distinct crystalline phase or has a multicomponent amorphous structure.

A particle size of the LLZO precursor 26 is 20 nm~200 nm. When the LLZO precursor 26 is used to form Li₇La₃Zr₂O₁₂, the LLZO precursor 26 includes at least one lithium-contained compound, at least one lanthanum-contained compound and at least one zirconium-contained compound. The at least one lithium-contained compound is selected from at least one of lithium oxide (Li₂O), lithium hydroxide (LiOH) and lithium carbonate (Li₂CO₃). The at least one lanthanum-contained compound is selected from at least one of lanthanum(III) oxide (La₂O₃), lanthanum hydroxide (La(OH)₃) and lanthanum carbonate (La₂(CO₃)₃). The at least one zirconium-contained compound is selected from at least one of zirconium dioxide (ZrO₂), zirconium(IV) hydroxide (Zr(OH)₄) and zirconium carbonate (Zr(CO₃)₂). The LLZO precursor 26 further includes at least one doping metal, which is selected from at least one of aluminum (Al), gallium (Ga), tantalum (Ta), niobium (Nb) and copper (Cu). An equivalent ratio of the at least one doping metal and the lithium in the LLZO precursor 26 is less than or equal to 0.25:3.

In the step 500, the mixer 150 is selected from a three-dimensional mixer, a parallel mixer, a blade mixer, a V-shaped mixer and a planetary mixer. In the mixing of the mixer 150, a mixing mediator is further added into the mixer 150. The mixing mediator is selected from zirconium dioxide balls, aluminum oxide balls, agate balls, and stainless steel balls. A filling ratio of the mixing mediator is 20% to 60%, which is a ratio of a total volume of the mixing mediator to a grinding volume of the mixer 150. A particle diameter of the mixing mediator is 0.5 cm~2 cm.

Step 510: placing the precursor mixture 28 into a sintering furnace 250 and performing an oxygen assisted sintering using the sintering furnace 250 to obtain a sintered powder 40 formed by a plurality of positive electrode particles 200. The oxygen assisted sintering is performed by increasing a temperature of the sintering furnace 250 to a first temperature of 400° C.~700° C. under a pure oxygen atmosphere and holding the first temperature for 1~4 hours. The lithium source 22 of the precursor mixture 28 is melted under the first temperature to be fully mixed with the nickel-cobalt-manganese hydroxide precursor 20 and the LLZO precursor 26 in the precursor mixture 28. Then the first temperature is increased to a second temperature of 800° C.~1000° C. and the second temperature is held for 6~12 hours. Then the second temperature is reduced to a room temperature under the pure oxygen atmosphere for obtaining the sintered powder 40.

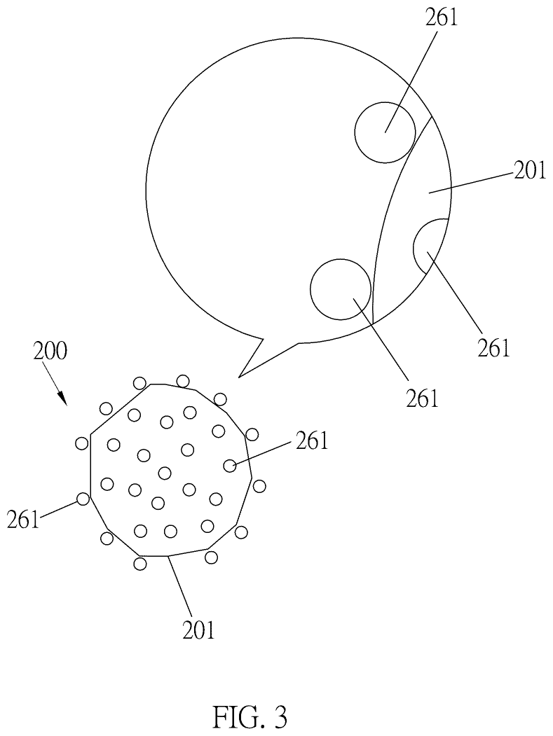

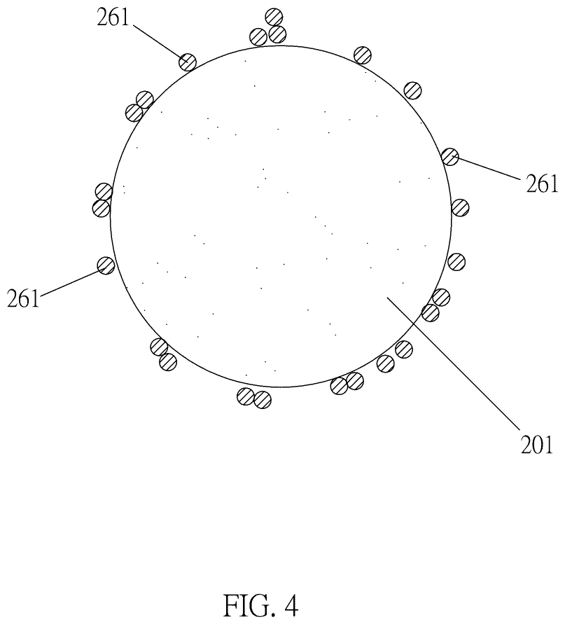

Referring to FIGS. 3 and 4, a melting point of the lithium source 22 is lower than the nickel-cobalt-manganese hydroxide precursor 20, the y conductor precursor 24 and the LLZO precursor 26 to cause that the lithium source 22 is first melted and is filled into the holes 21 of the nickel-cobalt-manganese hydroxide precursor 20 in the oxygen assisted sintering, and then the lithium source 22 is decomposed to form a lithium oxide with a specific high reactivity. The lithium oxide is reacted with the nickel-cobalt-manganese hydroxide precursor 20 to form a plurality of NCM (lithium nickel manganese cobalt oxide) particles 201 and is reacted with the LLZO precursor 26 to form a plurality of LLZO particles 261. The LLZO particles 261 are coated on an outer surface of the NCM particle 201. Each of the positive electrode particles 200 includes a corresponding NCM particle 201 coated with corresponding LLZO particles 261.

Step 520: performing a mechanical crushing on the sintered powder 40 and then performing a sifting on the sintered powder 40 using a sifter. The sifter has a mesh of 500. After the sifting, the NCM particles 201 have a D50 (mass-median-diameter, MMD) of 2~10 μm. A maximum radial size of each of LLZO particles 261 is less than 80 nm.

After the step 520, a carbon material mixing is then performed on the sintered powders 40, a plurality of first carbon nanotubes 30 and a plurality of nanoscale amorphous carbons 35 to form a plurality of carbon-material-coated positive electrode particles 300. The carbon material mixing may be performed by the following step 530A or step 530B. The steps 530A and 530B use different ways to perform the carbon material mixing.

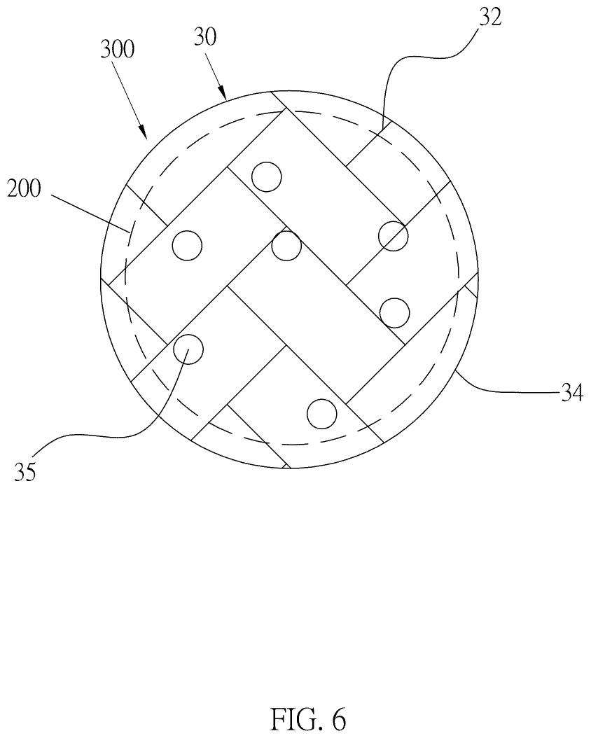

Step 530A: placing the sintered powders 40, the first carbon nanotubes 30 and the nanoscale amorphous carbons 35 into a dry mixer (such as a planetary mixer or a tumbler mixer); then mixing the sintered powders 40, the first carbon nanotubes 30 and the nanoscale amorphous carbons 35 using the dry mixer to form the carbon-material-coated positive electrode particles 300. Each of the carbon-material-coated positive electrode particles 300 includes a corresponding positive electrode particle 200, a plurality of corresponding first carbon nanotubes 30 and a plurality of corresponding nanoscale amorphous carbons 35. The corresponding first carbon nanotubes 30 and the corresponding nanoscale amorphous carbons 35 enclose (or are coated on) an outer side of the corresponding positive electrode particle 200 (as shown in FIG. 6). A mixing rotation speed of the dry mixer is 50 rpm~500 rpm. A mixing time of the dry mixer is 2~8 hours.

Step 530B: performing a first mixing for mixing the first carbon nanotubes 30 and the sintered powders 40 to form a first mixture, and then performing a second mixing for mixing the first mixture and the nanoscale amorphous carbons 35 to form the carbon-material-coated positive electrode particles 300. Each of the carbon-material-coated positive electrode particles 300 includes a corresponding positive electrode particle 200, a plurality of corresponding first carbon nanotubes 30 and a plurality of corresponding nanoscale amorphous carbons 35. The corresponding first carbon nanotubes 30 and the corresponding nanoscale amorphous carbons 35 enclose (are coated on) an outer side of the corresponding positive electrode particle 200. The first mixing and the second mixing are performed by a dry ball milling mixing or a wet ball milling mixing.

The first carbon nanotubes 30 include a plurality of short chain carbon nanotubes 32 and a plurality of long chain carbon nanotubes 34. A length of each of the short chain carbon nanotubes 32 is 0.5 μm to 1 μm. A length of each of the long chain carbon nanotubes 34 is 3 μm to 8 μm. In each of the carbon-material-coated positive electrode particles 300, a ratio of a total weight of the corresponding first carbon nanotubes 30 and a weight of the corresponding positive electrode particle 200 is 0.1%~2%.

Each of the short chain carbon nanotubes 32 is connected across between the corresponding LLZO particles 261 and the corresponding positive electrode particle 200. The long chain carbon nanotubes 34 wrap (or enclose) the positive electrode particles 200 to enhance a structural strength of the positive electrode particles 200. Preferably, the nanoscale amorphous carbons 35 are amorphous carbons of a Super P auxiliary agent. A size of each of the nanoscale amorphous carbons 35 is 20 nm~100 nm. In each of the carbon-material-contained positive electrode particles 300, the corresponding nanoscale amorphous carbons 35 are filled in a plurality of gaps of an interleaving structure formed by the corresponding first carbon nanotubes 30. In each of the carbon-material-coated positive electrode particles 300, a ratio of a total weight of the corresponding nanoscale amorphous carbons 35 and the weight of the corresponding positive electrode particle 200 is 0.1%~2%.

The first carbon nanotubes 30 serve to increase the conductivity of the electron by forming a plurality of conductive bridges between the LLZO particles 261 for conducting the electron on the positive electrode particles 200. The first carbon nanotubes 30 are randomly distributed on outer surfaces of the positive electrode particles 200. The first carbon nanotubes 30 have an extremely high electrical conductivity, so that the electron can pass through the first carbon nanotubes 30 and conduct between the LLZO particles 261 and the positive electrode particles 200, which increases the electrical conductivity of the positive electrode 100.

The first carbon nanotubes 30 and the nanoscale amorphous carbons 35 are used as an auxiliary agent. The nanoscale amorphous carbons 35 are in a form of particles, and the first carbon nanotubes 30 are in a form of long strips, gaps are formed in the interleaving structure of the first carbon nanotubes 30 on the positive electrode particle 200, and the gaps are unable to conduct the electric current. Therefore, the nanoscale amorphous carbons 35 is filled in the gaps to transmit the electric between the first carbon nanotubes 30 through the spanning of the nanoscale amorphous carbons 35, which further increases the transmitting efficiency of the electric current.

The advantages of the present invention are that an outer surface of the NCM particle is coated with LLZO particles. The LLZO particles have the ability of accommodating and guiding the lithium ions. The present invention use a single-stage sintering on the nickel-cobalt-manganese hydroxide precursor, lithium source and LLZO precursor to form the positive electrode particles, which reduces the manufacturing complexity, manufacturing time and production costs. The first carbon nanotubes and nanoscale amorphous carbons are further coated on the positive electrode particles for improving the electric conducting efficiency. The positive electrode having the positive electrode particles of the present invention can form a ternary cathode.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing positive electrode particles coated with ceramic particles using a dry mixing and a single-stage sintering; the positive electrode particles being used in a positive electrode inside a solid-state battery or semi-solid battery; the method comprising the steps of:
step A: placing a nickel-cobalt-manganese hydroxide precursor, a lithium source and a LLZO (lithium lanthanum zirconium oxide) precursor into a mixer; then mixing the nickel-cobalt-manganese hydroxide precursor, the lithium source and the LLZO precursor using the mixer to form a precursor mixture; wherein the nickel-cobalt-manganese hydroxide precursor is a hydroxide precursor for NCM (lithium nickel manganese cobalt oxide); the LLZO precursor is a precursor for LLZO, and the LLZO serves to form the ceramic particles; the nickel-cobalt-manganese hydroxide precursor is a granular material formed by plural particles; and an outer surface of each of the particles of nickel-cobalt-manganese hydroxide precursor has plural holes;
step B: placing the precursor mixture into a sintering furnace and performing an oxygen assisted sintering using the sintering furnace to obtain a sintered powder formed by a plurality of positive electrode particles; wherein a melting point of the lithium source is lower than the nickel-cobalt-manganese hydroxide precursor and the LLZO precursor to cause that the lithium source is first melted and is filled into the holes of the nickel-cobalt-manganese hydroxide precursor in the oxygen assisted sintering, and then the lithium source is decomposed to form a lithium oxide with a specific reactivity; the lithium oxide is reacted with the nickel-cobalt-manganese hydroxide precursor to form a plurality of NCM (lithium nickel manganese cobalt oxide) particles and is reacted with the LLZO precursor to form a plurality of LLZO particles; the LLZO particles are coated on an outer surface of the NCM particle; each of the positive electrode particles includes a corresponding NCM particle coated with corresponding LLZO particles.

2. The method as claimed in claim 1, wherein an equivalent ratio of the nickel-cobalt-manganese hydroxide precursor, the lithium source and the LLZO precursor is 1.0: (1.02~1.25):(0.005~0.02).

3. The method as claimed in claim 1, wherein a particle size of the nickel-cobalt-manganese hydroxide precursor is 1 μm~5 μm.

4. The method as claimed in claim 1, wherein the nickel-cobalt-manganese hydroxide precursor is a spherical precursor formed by whisker-like nickel-cobalt-manganese hydroxide.

5. The method as claimed in claim 1, wherein the nickel-cobalt-manganese hydroxide precursor is NiₓMn_{y}Co_{z}(OH)₂, wherein x>0.8 and x+y+z=1.

6. The method as claimed in claim 1, wherein the lithium source is formed by at least one of lithium hydroxide (LiOH), lithium carbonate (Li₂CO₃) and lithium nitrate (LiNO₃).

7. The method as claimed in claim 1, wherein the LLZO precursor is a granular material formed by plural particles; the LLZO precursor is formed by specific materials capable of forming a garnet-based solid-state electrolyte with a cubic crystal system by a co-firing with the lithium source; the specific materials include lanthanum-contained compound, oxides, hydroxides and carbonates; and a reaction intermediate formed by a coprecipitation or sintering of the specific materials has a structure with a distinct crystalline phase or has a multicomponent amorphous structure.

8. The method as claimed in claim 7, wherein the garnet-based solid-state electrolyte is Li₇La₃Zr₂O₁₂; the LLZO precursor includes at least one lithium-contained compound, at least one lanthanum-contained compound and at least one zirconium-contained compound;
the at least one lithium-contained compound is selected from at least one of lithium oxide (Li₂O), lithium hydroxide (LiOH) and lithium carbonate (Li₂CO₃); the at least one lanthanum-contained compound is selected from at least one of lanthanum(III) oxide (La₂O₃), lanthanum hydroxide (La(OH)₃) and lanthanum carbonate (La₂(CO₃)₃); and the at least one zirconium-contained compound is selected from at least one of zirconium dioxide (ZrO₂), zirconium(IV) hydroxide (Zr(OH)₄) and zirconium carbonate (Zr(CO₃)₂).

9. The method as claimed in claim 7, wherein the LLZO precursor further includes at least one doping metal; and the at least one doping metal is selected from at least one of aluminum (Al), gallium (Ga), tantalum (Ta), niobium (Nb) and copper (Cu).

10. The method as claimed in claim 1, wherein in the step A, the mixer is selected from a three-dimensional mixer, a parallel mixer, a blade mixer, a V-shaped mixer and a planetary mixer; in the mixing of the mixer, a mixing mediator is further added into the mixer; the mixing mediator is selected from zirconium dioxide balls, aluminum oxide balls, agate balls, and stainless steel balls; a filling ratio of the mixing mediator is 20% to 60%, which is a ratio of a total volume of the mixing mediator to a grinding volume of the mixer; and a particle diameter of the mixing mediator is 0.5 cm~2 cm.

11. The method as claimed in claim 1, wherein in the step B, the oxygen assisted sintering is performed by increasing a temperature of the sintering furnace to a first temperature of 400° C.~700° C. under a pure oxygen atmosphere and holding the first temperature for 1~4 hours; the lithium source of the precursor mixture is melted under the first temperature to be fully mixed with the nickel-cobalt-manganese hydroxide precursor and the LLZO precursor in the precursor mixture; then the first temperature is increased to a second temperature of 800° C.~1000° C. and the second temperature is held for 6~12 hours; and then the second temperature is reduced to a room temperature under the pure oxygen atmosphere for obtaining the sintered powder.

12. The method as claimed in claim 1, further comprising the step of:
step C: performing a mechanical crushing on the sintered powder and then performing a sifting on the sintered powder using a sifter.

13. The method as claimed in claim 12, wherein after the sifting, the NCM particles have a D50 (mass-median-diameter, MMD) of 2~10 μm; and a maximum radial size of each of LLZO particles is less than 80 nm.

14. The method as claimed in claim 12, wherein after the step C, the sintered powders is mixed with a plurality of first carbon nanotubes and a plurality of nanoscale amorphous carbons to form a plurality of carbon-material-coated positive electrode particles; and each of the carbon-material-coated positive electrode particles includes a corresponding positive electrode particle, a plurality of corresponding first carbon nanotubes and a plurality of corresponding nanoscale amorphous carbons.

15. The method as claimed in claim 14, wherein the first carbon nanotubes include a plurality of short chain carbon nanotubes and a plurality of long chain carbon nanotubes; a length of each of the short chain carbon nanotubes is 0.5 μm to 1 μm; a length of each of the long chain carbon nanotubes is 3 μm to 8 μm; each of the short chain carbon nanotubes is connected across between the corresponding LLZO particles and the corresponding positive electrode particle; the long chain carbon nanotubes serve to wrap the positive electrode particles; a size of each of the nanoscale amorphous carbons is 20 nm~100 nm; and in each of the carbon-material-contained positive electrode particles, the corresponding nanoscale amorphous carbons are filled in a plurality of gaps of an interleaving structure formed by the corresponding first carbon nanotubes.
